(19) United States
(12) Patent Application Publication
(10) Pub. No.: US 2006/0233626 A1
(43) Pub. Date: Oct. 19, 2006

(54) Screw with compound recesses

(76) Inventor: Chao-Wei Lin, Tainan City (TW)

Correspondence Address: PRO-TECTOR INTERNATIONAL SERVICES, 20775 NORADA CT., SARATOGA, CA, 95070, US

(21) Appl. No.: 11/144,533

(22) Filed: Jun. 3, 2005

(30) Foreign Application Priority Data
Apr. 18, 2005 (TW) 94112191

(51) Int. Cl. F16B 39/34

(52) U.S. Cl. 411/304

(57) ABSTRACT

A screw is disclosed to have a compound recess in the head thereof, which compound recess having a center square portion, four symmetrical fan-shaped portions in contact with the four angles of the center square portion, and a narrow elongated slot portion extending across two opposite angles of the center square portion. The ratio between the depth of the narrow elongated slot portion and the depth of four angles of the center square portion is within 2/3:1.

### BACKGROUND OF THE INVENTION

1. Field of the Invention

The present invention relates to screws and more particularly, to a screw with compound recesses, which fits a variety of commercially available screwdrivers, enabling the attached screwdriver to produce a high driving torque.

2. Description of the Related Art

A conventional fastener drive recess types include slot recess (A) shown in FIG. 1, cross recess (B) shown in FIG. 2, cross-square combination recess (C) shown in FIG. 3, square cross (D) shown in FIG. 4, and double-cross recess (E) shown in FIG. 5. Drive recess structures of aforementioned types generally cannot stand comparatively large torque due to their structural weakness and uneven pressure distribution. Typically, if a screw of any of the aforementioned recess types resists turning, then upon applying an increased torque to the driver bit, it slips upwardly out of the drive recess. The more frequent this slippage occurs, the worse damage is imposed on both the drive recess and the drive bit.

There are also known screws with compound recesses (see FIGS. 6 and 7) having a slot recess transversely extending coast-to-coast and formed integral with a square cross recess (see FIG. 6) or double-cross recess (see FIG. 7). These screws fit screwdrivers having different drive recess types. However, these screws still cannot have the attached screwdriver to produce a high driving torque.

### SUMMARY OF THE INVENTION

The present invention has been accomplished under the circumstances in view. It is one object of the present invention to provide a screw, which fits a variety of regular commercially available screwdrivers. It is another object of the present invention to provide a screw, which prevents slippage of the attached screwdriver. It is still another object of the present invention to provide a screw, which enables the attached screwdriver to produce a high driving torque. To achieve these and other objects and according to one aspect of the present invention, the screw comprises a compound recess in the head thereof. The compound recess has a center square portion, four symmetrical fan-shaped portions in contact with the four angles of the center square portion, and a narrow elongated slot portion extending across two opposite angles of the center square portion. According to another aspect of the present invention, the ratio between the depth of the narrow elongated slot portion and the depth of four angles of the center square portion is within 2/3:1.

### BRIEF DESCRIPTION OF THE DRAWINGS

FIG. 1 is a top view of a screw with a slot recess according to the prior art.

FIG. 2 is a top view of a screw with a cross recess according to the prior art.

FIG. 3 is a top view of a screw with a cross-square combination recess according to the prior art.

FIG. 4 is a top view of a screw with a square recess according to the prior art.

FIG. 5 is a top view of a screw with a double-cross recess according to the prior art.

FIG. 6 is a top view of a screw with a slot recess transversely extended coast-to-coast and formed integral with a cross-square recess according to the prior art.

FIG. 7 is a top view of a screw with a slot recess transversely extended coast-to-coast and formed integral with a double-cross recess.

FIG. 8 is a perspective side view of a screw constructed according to a first embodiment of the present invention.

FIG. 9 is a top plain view of the screw shown in FIG. 8.

FIG. 10 is a side view of a punching tool for making a compound recess according to the first embodiment of the present invention.

FIG. 11 is a sectional view taken along line B-B′ of FIG. 10.

FIG. 12 is a top plain view of a screw constructed according to a second embodiment of the present invention.

FIG. 13 is a side view of a punching tool for making a compound recess according to the second embodiment of the present invention.

FIG. 14 is a sectional view taken along line C-C′ of FIG. 13.

FIG. 15 is a sectional view taken along line A-A′ of FIG. 9.

FIG. 16 is a schematic side view of a punching tool for making a compound recess according to the present invention.

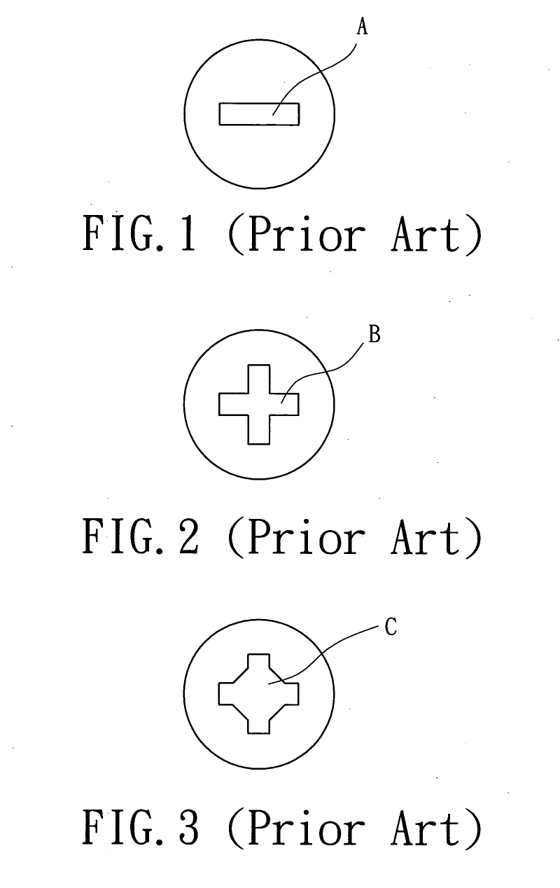

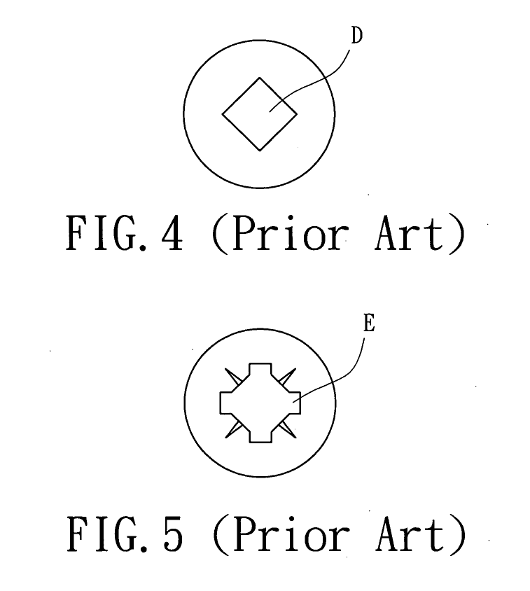

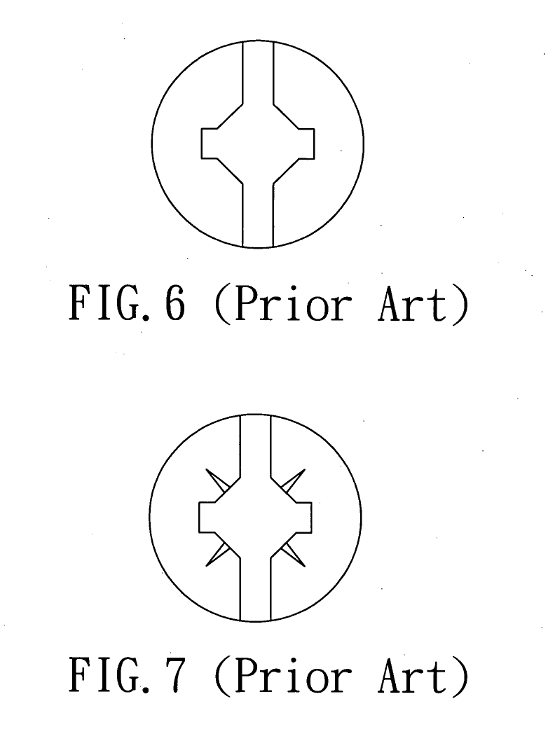

### DETAILED DESCRIPTION OF THE PREFERRED EMBODIMENT

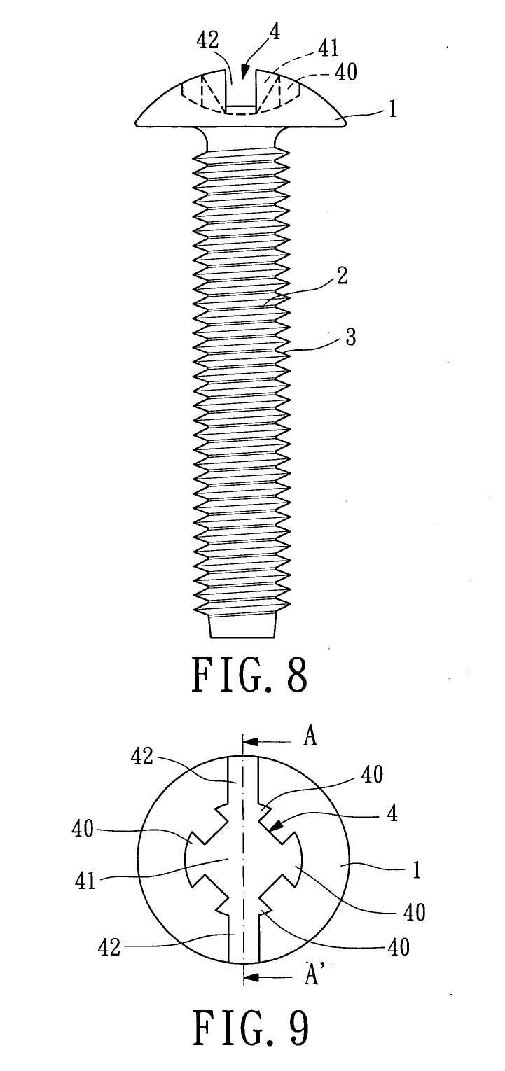

Referring to FIG. 8, a screw in accordance with the first embodiment of the present invention is shown comprising a head 1, a shank 2 perpendicularly extending from the center area of one side of the head 1, and a male thread 3 extending around the periphery of the shank 2. The head 1 can have a flat countersunk, cup-like, cone-like, rounded, oval profile or pan head, etc. Further, the head 1 has a compound drive recess 4 that fits a variety of conventional screwdrivers (see FIG. 9). The compound drive recess 4 comprises a center square portion 41, four symmetrical fan-shaped portions 40 in contact with the four angles of the center square portion 41, and a narrow elongated slot portion 42 extending across two opposite angles of the center square portion 41.

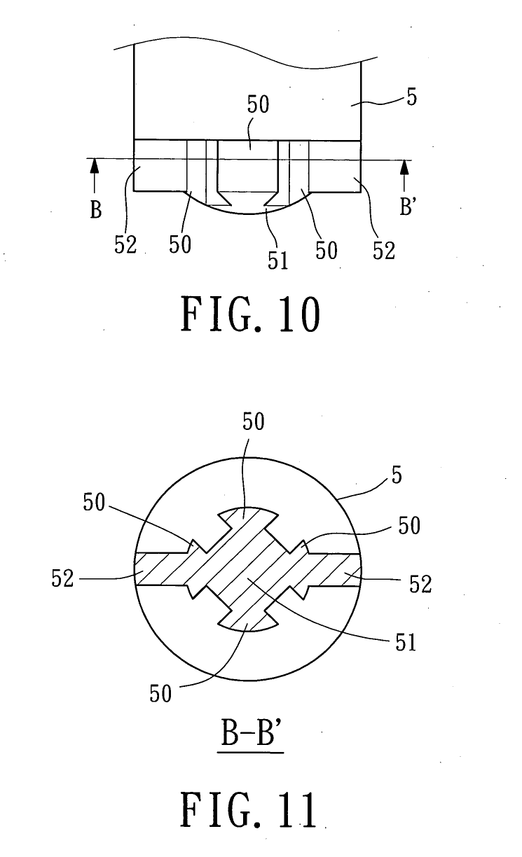

A punching tool 5 is shown adapted to make the aforesaid compound drive recess 4 on the head 1 of a screw (see FIGS. 10 and 11). The punching tool 5 comprises four fan-shaped cutters 50, a center square cutter 51 surrounded by the four fan-shaped cutters 50, and two straight cutting ribs 52 extending from two opposite angles of the center square cutter 51 and aligned in a line.

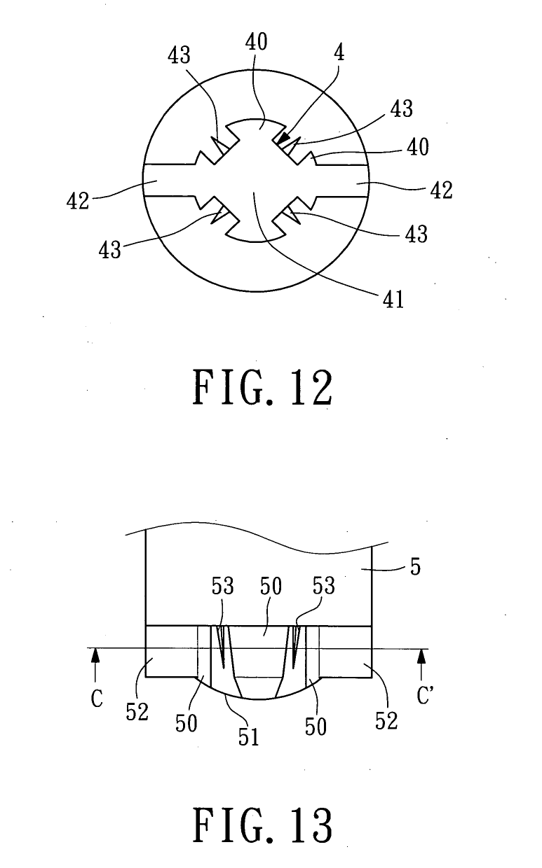

FIG. 12 shows an alternate form of the present invention. This embodiment is substantially similar to the aforesaid first embodiment with the exception that four pointed drive recess portions 43 are formed in the head 1 and respectively slantingly extending from the four sides of the center square portion 41. The punching tool 5 has four pointed cutting tips 53 respectively slantingly extending from the four sides of the center square cutter 51 (see FIGS. 13 and 14).

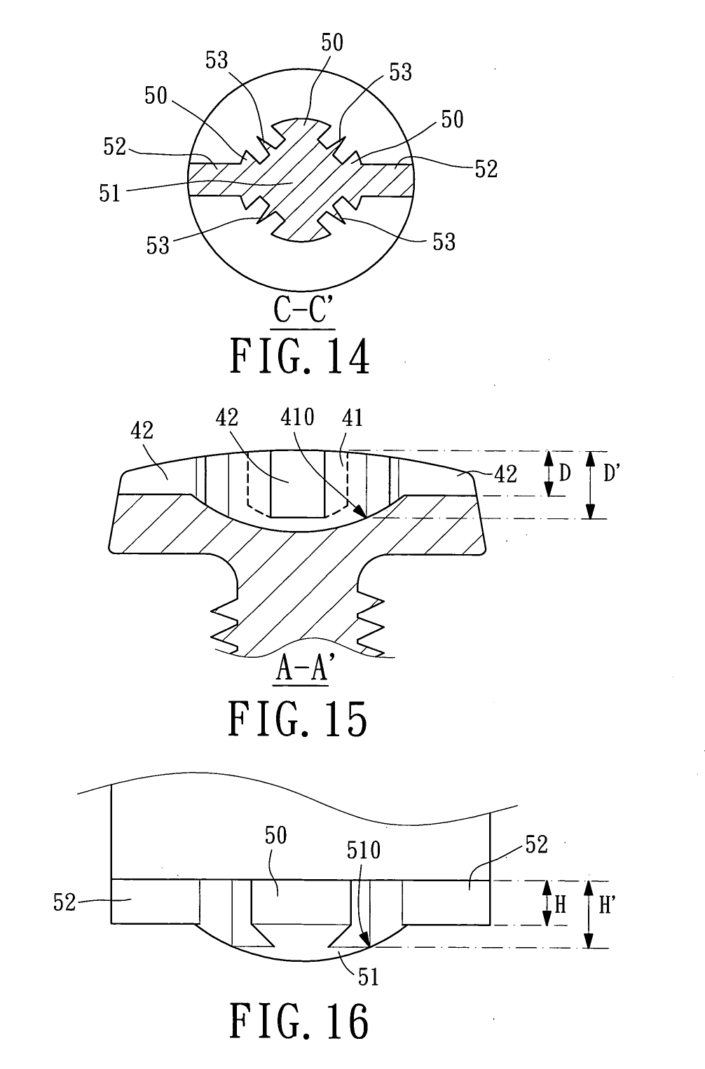

Referring to FIG. 15, the ratio between the depth D of the narrow elongated slot portion 42 of the compound drive recess 4 and the depth D′ of the four angles 410 of the center square portion 41 is within 2/3:1; the ratio between the height H of the straight cutting ribs 52 and the height H′ of the four angles 510 of the center square cutter 51 is within 2/3:1.

A screw constructed according to the present invention fits with a slot drive, square drive, Phillips (cross) drive, Pozi drive (double cross), or cross-square drive. A screw constructed according to the present invention also fits with a drive made according to U.S. Pat. No. 6,289,775. After engagement of the drive with the compound recess of the screw, the drive does not slip from the head of the screw, and can produce a high driving torque.

Although particular embodiments of the invention has been described in detail for purposes of illustration, various modifications and enhancements may be made without departing from the spirit and scope of the invention.

What the invention claimed is:

1. A screw comprising a threaded shank and a head at one end of said shank, said head having a compound recess in a top surface thereof, said compound recess comprising a center square portion, and four symmetrical fan-shaped portions in contact with four angles of said center square portion, wherein said compound recess further comprises a narrow elongated slot portion extending across two opposite angles of said center square portion.

2. The screw as claimed in claim 1, wherein said compound recess further comprises four pointed drive recess portions respectively slantingly extending from four sides of said center square portion.

3. The screw as claimed in claim 1, wherein the ratio between the depth of said narrow elongated slot portion and the depth of four angles of said center square portion is within 2/3:1.

4. The screw as claimed in claim 2, wherein the ratio between the depth of said narrow elongated slot portion and the depth of four angles of said center square portion is within 2/3:1.
